(19) United States
(12) Patent Application Publication
(10) Pub. No.: US 2016/0053537 A1
(43) Pub. Date: Feb. 25, 2016

(54) HIGH EFFICIENCY SYSTEM AND METHOD FOR CONTROLLING ONE OR MORE ROLLER SHADES

(71) Applicant: Shawn Dybdahl, Las Vegas, NV (US)

(72) Inventor: Shawn Dybdahl, Las Vegas, NV (US)

(21) Appl. No.: 14/466,321

(22) Filed: Aug. 22, 2014

(51) Int. Cl. E06B 9/68

(52) U.S. Cl. CPC E06B 9/68; E06B 2009/6809

(57) ABSTRACT

The present invention is directed, in part, to a high efficiency manually controlled or motorized roller shade device, the device being capable of rolling and unrolling one or more window or other type of shade simultaneously employing use of a single motor. The invention employs several elements including roller shades, optionally, a motorized device capable of rolling and unrolling shade coverings, one or more grudgens configured on either side of the roller shades, with each grudgen containing in its center a square hole that receives a square rod, the square rod acting to connect a first shade roller to a second shade roller, the second shade roller being configured adjacent to the first shade roller. The addition of more grudgens to additional shade rollers allows the single manually controlled or motorized device to control the rolling and unrolling of multiple shade rollers simultaneously without the need for multiple rolling motors.

### FIELD OF THE INVENTION

The present invention relates generally to an efficient system and methods for controlling one or more roller shades in a residential or commercial building or structure. More in particular, the invention relates to a manual or motorized system that efficiently rolls and unrolls one or multiple roller shades simultaneously employing use of a single manually controlled or motorized mechanism.

### BACKGROUND OF THE INVENTION

A typical roller shade system includes several elements including a flexible shade made from a durable flexible fabric, with the flexible shade wrapped around one or more elongated roller tubes. Mechanisms for rolling and unrolling shades have been numerous and varied in the prior art. For the most part however, motorized shades employ a single motor that rolls or unrolls a single roller shade over a single window or window covering. With regard to motorized roller shades that work to roll and unroll one or more roller shades, the prior art yields only highly complicated mechanisms that are prone to break down, are cumbersome and which are very expensive for the average consumer.

Various devices have sought to address issues in providing a motorized roller shade that is both efficient as well as reasonably cost effective to the average consumer, however none have fully addressed shortcomings currently existing in the art. For example, U.S. Pat. No. 8,692,498 describes a system and method for controlling one or more roller shades wherein the roller system includes an optical sensor configured for capturing an image frame of the flexible shade material at a plurality of linear positions along the shade material.

The patent further describes a roller shade controlling apparatus comprising a shade system includes a digital signal processor configured for processing the plurality of captured images frames to determine changes in position of the flexible shade material as the lower end of the shade moves from a first position to a second position.

The invention however, suffers from highly complicated technology requirements resulting in significant expense to the average consumer especially when considering that several of the systems are required for the typical home or commercial building.

Likewise, U.S. Pat. No. 8,659,246 to Mullet et al., describes a high efficiency roller shade that includes a shade tube in which a motor unit, a controller unit and a power supply unit wherein the controller unit includes a controller to control the motor. The invention is further described to include a motorized unit that includes a bearing, rotatably coupled to another support shaft, a DC gear motor and a counterbalancing device, such as for example, a rotating perch.

Like the '498 patent however, the device described in the '246 patent is extremely complicated and is prone to malfunction. Further, given the number of elements required to assemble the apparatus, the cost associated with the device is undoubtedly significantly, especially to the average consumer. It is further unclear how efficient the device actually is in rolling and unrolling roller shades and indeed, the roller described, is capable of rolling and unrolling one roller shade at a time.

Numerous other devices in the prior art likewise fail to address the limitations of providing the public with a motorized roller shade that rolls and unrolls one or more rollers simultaneously with the use of a single motorized device.

Accordingly, difficulties in the field of mechanized, multi-roller shades remain. Existing solutions fail to address particular deficiencies that confront businesses and consumers seeking alternatives to the existing art. Further, a solution to advancing costs and time saving measures for greater implementation of energy conserving options remains elusive. The present invention seeks to address these shortcomings.

### SUMMARY OF THE INVENTION

The present invention is directed to roller shade controlling apparatus and shade system that employs a manually controlled or motorized device that controls the upward and downward movement of a roller shade. The motorized shade roller also includes one or more roller shades, one or more grudgen ends, one or more round protrusions from the grudgens, the round protrusions containing within them, square holes, and one or more square pegs that control the rolling and unrolling of the one or more roller shades and attach to the square holes configured into the grudgen. The present invention provides a device and methods by which a consumer or owner of the device can control the rolling and unrolling of one or more roller shades simultaneously using a single motorized device.

The roller shade controlling apparatus and shade system of the present device is prepared from several elements including one or more grudgens that fit on either side of a roller shade. The grudgens further employ a round outward protrusion configured on each grudgen that contains within the center of the grudgen a square hole, the square hole acting to receive a square peg that connects one roller shade to another by means of the grudgen configured on either side of the roller shade. The motorized device further employs brackets to securely hold the grudgens and round outward protrusions in position while placed at either end of the roller shade to which the grudgen or grudgens are attached.

To operate the roller shade controlling apparatus and shade system, a central motor, capable of rolling and unrolling a typical shade roller, is employed or can be operated manually. In particular, the central motor is configured between an end bracket and a roller shade. The central motor is connected to AC power and acts to roll and unroll a roller shade to which it is attached. That roller shade, in turn, is attached to an adjacent roller shade by means of the grudgen, the round protrusion bearing a square hole and a square peg.

The present invention is directed to a roller shade controlling apparatus and shade system comprising a manually controlled or motorized device, wherein the motorized device includes a motor capable and possessing sufficient power to roll and unroll one or more roller shades simultaneously. The apparatus also includes one or more roller shades, one or more brackets, one or more grudgens and one or more square rods. The grudgens are configured with a bushing and include a center area configured with a square hole and a round protrusion. The apparatus further includes a plurality of square rods, the square rods being configured to fit within the square hole of the grudgen. As described, the square rods of the invention are also prepared using flexible materials so that multiple roller shades can be interconnected on uneven or curve wall surfaces. In this embodiment, a single motor rolls and unrolls a plurity of interconnected roller shades

The grudgens of the motorized roller shade controlling apparatus are configured and installed on both ends of a roller shade. Further, one end of a square rod is fitted into the square hole in a first grudgen, the first grudgen being fitted onto one end of a first roller shade and wherein the other end of the square rod is fitted into the square hole of a second grudgen, wherein the second grudgen is fitted onto a second roller shade thereby connecting the first roller shade to the second roller shade. The motorized roller shade controlling apparatus also includes one or more roller shades that are connected together with one or more square rods and one or more said grudgens so that all of said one or more roller shades rolls and unrolls when said motor is turned on. The apparatus can also be controlled by manual means in the event a roller motor is not attached to the apparatus.

The invention further includes a kit for assembling a motorized roller shade controlling apparatus that includes, in combination:

a. one or more roller shades;

b. one or more grudgens;

c. one or more brackets;

d. a standard roller shade motor;

e. one or more square rods;

wherein the motor is capable and possesses sufficient power to roll and unroll one or more of the roller shades simultaneously, the method of assembling the kit also including configuring one or more grudgens on the ends of one or more roller shades wherein one or more square rods are installed into one or more said grudgens within square holes prepared in the center of the one or more grudgens. Further, a first square rod acts to interconnect a first grudgen configured on one end of a first roller shade with a second roller shade configured with a second grudgen on one of its ends. The interconnection enabling the motor to roll and unroll said first and second roller shades simultaneously.

The kit also includes the motor which is configured at a first end of a first roller shade and a first grudgen is configured at the other end of the first roller shade and wherein a first bracket is configured at the first end of the first roller shade and a second bracket is configured at the other end of the first roller shade. The grudgens of the invention include a bushing, and include a center area configured with a square hole and a round protrusion, and a square rod, the square rod being configured to fit within said square hole of one or more grudgens. The kit is designed to interconnect a third, fourth and fifth roller shade or more by means of installing square rods into the grudgens installed between the roller shades. In being so interconnected, all the roller shades roll and unroll simultaneously with the motor.

The invention further includes a method of rolling and unrolling one or more roller shades. The method including assembly of a motorized roller shade controlling apparatus that includes one or more brackets, one or more grudgens, one or more square rods, one or more roller shades and at least one motor capable of rolling and unrolling one or more roller shades simultaneously. The method is accomplished by connecting said motor to one end of a first roller shade and connecting a first grudgen to the other end of the first roller shade. The first grudgen is fitted with one end of a first square rod and the first square rod fits through an opening in a first bracket, and the other end of the first square rod fits into a square hole on a second grudgen where, the second grudgen is connected to a second roller shade. Accordingly, the connected assembly connects the first roller shade with the second roller shade. When activated, the motor will roll and unroll the first and second roller shades.

The method also includes two or more roller shades that are connected by one or more square rods fitted into one or more grudgens, the one or more grudgens fitted onto the ends of two or more roller shades.

The method of also includes one or more grudgens that are configured with raised protrusions, wherein the raised protrusions are configured with a square hole in the center, wherein the square hole acts to receive one end of a first square rod and the other end of the first square rod fits into a square hole configured into an adjacent grudgen installed on one end of an adjacent roller shade.

The method of the invention also includes a motor that rolls and unrolls a plurality of roller shades simultaneously wherein the plurality of roller shades are interconnected with a plurality of square rods and a plurality of grudgens wherein the motorized roller shade controlling apparatus is configured with a plurality of brackets that attach the apparatus to a wall or other flat surface.

### BRIEF DESCRIPTION OF THE DRAWINGS

FIG. 1 depicts a perspective of the invention wherein a motorized roller shade controlling apparatus is configured with a grudgen at one end of the roller shade and the other end of the roller shade connected to a motor capable of rolling and unrolling the roller shade.

FIG. 2 depicts a basic configuration of assembly aspects of the motorized roller shade controlling apparatus. In particular, 2 grudgens are provided and are shown bearing round protrusions located in the center area of each grudgen. Between the two grudgens is a square peg that acts to connect the two grudgens.

FIG. 3 depicts a basic assembly diagram of the motorized roller shade controlling apparatus wherein the motor is attached to a bracket on one side and a roller shade on the other side of the motor. On the other end of the roller shade a grudgen is connected, the grudgen allowing placement of a square rod therein to connect other roller shades.

FIG. 4 illustrates a similar perspective to that of FIG. 3 however from an opposite end of the motorized roller shade controlling apparatus. In the Figure, a bracket is shown adjacent to a grudgen wherein the grudgen in turn is connected to one end of a roller shade. In the illustration, a second grudgen is configured on the other end of the roller shade.

FIG. 5 illustrates the motorized roller shade controlling apparatus wherein up to 3 roller shades are shown in a raised position and are connected to one another via one or more brackets, one or more grudgens and one or more roller shades.

FIG. 6 illustrates the motorized roller shade controlling apparatus wherein up to 3 roller shades are shown in a raised position and are connected to one another via one or more brackets, one or more grudgens and one or more roller shades.

### DETAILED DESCRIPTION OF THE INVENTION

The present invention is directed to a novel and highly efficient roller shade controlling apparatus wherein one or more roller shades are connected to one another and are either rolled or unrolled, according to the user's needs, employing use of a single motor or manual control to do so. The invention does so by using one or more brackets, one or more grudgens, one or more square rods and one or more roller shades, that act in concert with a single motor in order to roll and unroll simultaneously using the single motor or manual control.

The invention is more particularly directed to a roller shade controlling apparatus including a shade system, the shade system including one or more roller shades, one or more brackets, one or more grudgens, one or more square rods. The grudgens of the invention are desiged with a bushing, as well as a center area configured with a square hole and a round protrusion. The square rods are configured to fit within the square hole of one or more grudgens. The grudgens are configured on both ends of one or more roller shades, wherein the square rods interconnect one or more roller shades so that when a first interconnected roller shade is rolled or unrolled, all other interconnected roller shades are rolled or unrolled simultaneously. Interconnection of the roller shades includes the steps of fitting a first end of a first square rod into the square hole of a first grudgen, the first grudgen being fitted onto one end of a first roller shade. The other end of the square rod is fitted into the square hole of a second grudgen, wherein the second grudgen is fitted onto a second roller shade thereby interconnecting said first roller shade to said second roller shade. In doing so, a user can interconnect as many roller shades as desired.

The roller shade controlling apparatus and shade system also includes in another embodiment a motor capable and possessing sufficient power to roll and unroll said one or more roller shades simultaneously. Related to this embodiment, the roller shade controlling apparatus enables a user to control one or more roller shades that are interconnected with one or more square rods and one or more grudgens so that all interconnected roller shades roll and unroll when the motor is turned on. Further included with the shade system are square rods that are flexible so that one or more roller shades can be interconnected on curved or uneven wall or other surfaces. The roller shade controlling apparatus and shade system also includes a light sensor for automatic activation of the rolling and unrolling of interconnected roller shades.

The invention further relates to a kit for assembling a shade system, the shade system including, in combination:

a. one or more roller shades;

b. one or more grudgens;

c. one or more brackets;

d. one or more square rods;

wherein one or more grudgens includes a bushing, the grudgens also including a center area configured with a square hole and a round protrusion. Further, the square rods are configured to fit within the square hole of the one or more grudgens wherein the grudgens are configured on both ends of one or more roller shades. In this manner, the square rods interconnect one or more roller shades so that when a first interconnected roller shade is rolled or unrolled, all other interconnected roller shades are rolled or unrolled simultaneously. The interconnection of roller shades includes the steps of fitting a first end of a first square rod into the square hole of a first grudgen, the first grudgen being fitted onto one end of a first roller shade and wherein the other end of the square rod is fitted into the square hole of a second grudgen, wherein said second grudgen is fitted onto a second roller shade thereby interconnecting the first roller shade to the second roller shade. In doing so, a user can interconnect as many roller shades as desired.

The kit for assembling a shade system also includes, in a preferred embodiment a motor, wherein the motor is capable and possesses sufficient power to roll and unroll one or more roller shades simultaneously. In particular, the kit of the invention includes a motor configured at a first end of a first roller shade and a first grudgen is configured at the other end of the first roller shade and wherein a first bracket is configured at the first end of the first roller shade and a second bracket is configured at the other end of the first roller shade. As part of this embodiment the kit includes square rods that consist of flexible material so that the roller shades can be interconnected when mounted on curved, rounded or otherwise uneven surfaces.

The invention further provides a method of rolling and unrolling one or more roller shades comprising assembly of a roller shade system that includes one or more brackets, one or more grudgens, one or more square rods, one or more roller shades and at least one motor capable of rolling and unrolling one or more roller shades simultaneously. The grudgens are configured with raised protrusions, wherein the raised protrusions are configured with a square hole in the center, wherein the square hole is designed to receive one end of a first square rod and the other end of the first square rod is designed to fit into a square hole configured into an adjacent grudgen installed on one end of an adjacent roller shade. The assembly also includes the steps of connecting said motor to one end of a first roller shade and connecting a first grudgen to the other end of the first roller shade, wherein the first grudgen is fitted with one end of a first square rod and the first square rod fits through an opening in a first the bracket, and the other end of the first square rod fits into a square hole on a second grudgen, the second grudgen being connected to a second roller shade. In such a configuration the first roller shade is interconnected with the second roller shade. The motor, when activated, will roll and unroll said first and second roller shades.

The method of claim 10 wherein the assembly also includes the steps of fitting a first end of a first square rod into the square hole of a first grudgen, the first grudgen being fitted onto one end of a first roller shade and wherein the other end of the square rod is fitted into the square hole of a second grudgen, wherein said second grudgen is fitted onto a second roller shade. In so doing, the first roller shade is interconnected with the second roller shade allowing a user to interconnect as many roller shades as desired.

Related to this embodiment, the method employs use of a motor to roll and unroll a plurality of roller shades simultaneously wherein the roller shades are interconnected with a plurality of square rods and a plurality of grudgens. Also included in the method is the use of a plurality of brackets that attach said apparatus to a wall or other flat surface. The method also includes square rods comprised of a flexible material so that roller shades can be interconnected on a curved, rounded or uneven wall surface. The method also allows a user to employ use of the roller shade controlling apparatus by manual control or employing use of a motor.

It is therefore, a primary object of the present invention to provide a roller shade apparatus and motorized device that rolls and unrolls one or more window or other roller shades simultaneously with the use of a single motor. The prior art is replete with devices to roll and unroll roller shades however, none has addressed the long standing shortcoming of allowing consumers to save money on roller shade devices that employ a single motor to roll and unroll multiple roller shades simultaneously. The present invention addresses this shortcoming in the art.

The invention discloses a motorized roller shade controlling apparatus wherein the apparatus is assembled using the brackets, grudgens, square rods and roller shades as well as a motor capable of rolling and unrolling several roller shades at the same time. In one embodiment, a grudgen is configured to fit over one end of a roller shade. The grudgen contains in its center, a raised round protrusion that within its center, houses a square hole. With regard to the other end of the roller shade in this instance is either a motor connected to the roller shade, or a second grudgen is connected to the roller shade. The apparatus can also be controlled by manual means in the event a roller motor is not attached to the apparatus

To assemble the device a shade roller motor is attached to one end of a roller shade on one end of the roller shade. A grudgen is configured on the other end of the roller shade with the grudgen possessing a raised, round protrustion in its center. Within the center of the round protrusion is a square hole designed to receive one end of a square rod. Over the grudgen on the second end of the roller shade is configured a bracket that connects the rolling apparatus to the wall. The bracket is prepared with a round hole through which the square rod easily fits therethrough.

In a preferred embodiment, the invention includes two, three, four and even more roller shades that have been connected in tandem employing use of brackets, square rods, grudgens and roller shades in sufficient number to connect each of the roller shades to one another and in turn, the roller shades to a motor that rolls and unrolls the roller shades simultaneously. As part of a preferred embodiment of the invention, the square rods of the apparatus are flexible, thus allowing multiple roller shades to be interconnected to one another even in instances wherein the wall is curved or uneven. In such a case the square rod flexes so that roller shades can be interconnected to one another on a curved surface. The preferred embodiment allows multiple roller shades to be interconnected on curved walls and other surfaces.

Alternatively, in yet another preferred embodiment, the invention is available to consumers as a kit wherein users assemble the motorized roller shade controlling apparatus from a packaged kit. In such a configuration, users are able to customize roller shade coverings in any particular home or commercial establishment. The kits of the invention comprise a pre-formed assembly that includes grudgens attached on each end of roller shades provided in the kit. The kit also includes brackets that are easily installed onto the grudgens and roller shades. Hardware, including drywall screws, nuts and bolts, are also included in the kit in order for users to secure the brackets and in turn, the roller shades to the wall of the area being covered. Also included in the kit is a motor that is attached to one end of a roller shade of the kit. This roller shade is in turn, connected by grudgens, brackets and a square rod to a second roller shade that is fitted with a grudgen at each end of the second roller shade.

The user can thereafter, add as many roller shades as the user requires to customize the user's home or business. In so doing, the kit provides square rods whose length can be adjusted in order to accommodate the needs of various users. For example, square rods of the kit will come in lengths between 3 inches to 6 feet, or longer as necessary, so that users can customize roller shades in their home or business. Long square rods of the kit can easily be cut by users during installation so that the lengths of the rods are appropriate for the user's home or business needs. Accordingly, square rods of the invention can be cut to any length a user will require in order to customize their home or business window covering needs.

As used herein, the term “grudgen” refers to an element of the invention designed to fit over one or both ends of a roller shade. In particular, the grudgen is designed to connect a roller shade to a square rod wherein the square rod can be connected to a second grudgen attached to one end of a second roller shade. In so doing, the grudgens of the inventions act in concert with other elements of the apparatus to connect one or more roller shades to a motor that will roll and unroll the one or more shades with the single motor.

As used herein the terms “round protrustion”, refers to the element of the grudgen that is configured at the center of the grudgen. In particular, the round protrusion is in the center of the grudgen and at the center of the round protrusion there is a square hole configured therein designed to receive and hold one end of a square rod.

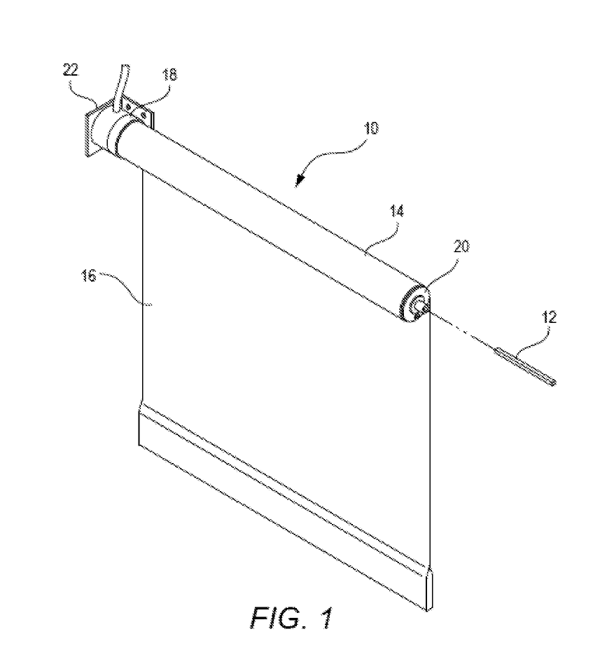

Turning now to the substance of FIGS. 1 to 6 and the preferred embodiments of the invention. FIG. 1 illustrates several basic elements of the motorized roller shade controlling apparatus and kit thereof 10. As shown, a roller 14 is provided and is illustrated with a shade 16 together forming a roller shade. A grudgen 20 is illustrated at one end of the roller shade with a round protrusion at the center of grudgen, the center portion providing a square hole that will accommodate a square rod 12 therethough. Shown at the other end of the roller shade is a bracket 22 that attaches the motorized roller shade controlling apparatus to an adjacent wall. A motorized device, such as a standard roller shade motor 18 is provided at the end of the roller shade to provide power and rolling/unrolling capability to the apparatus.

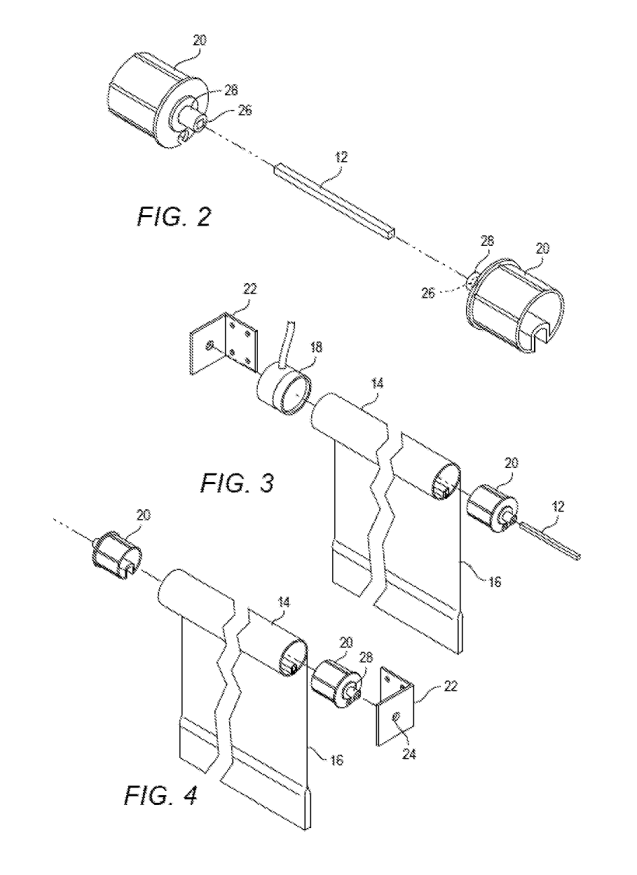

FIG. 2 illustrates the grudgen and square rod configuration of the motorized roller shade controlling apparatus. In particular, two grudgens 20 are shown connected by a square rod 12, the square rod configured between the two grudgens. The square rod is fit into the grudgen via a square hole 26 that is centered inside a round protrusion 28 on the grudgen. As described, the square rod is provided to users as well as in a kit, at lengths that can be adjusted to the user's particular needs. Long square rods (e.g., 6 feet long or more) are provided in the kit and for installation of the apparatus for instances in which the user requires a long square rod to interconnect two roller shades. The long square rods of the invention and kit can be cut to more suitable lengths for instances in which a user doesn't require long square rods to interconnect two roller shades.

FIG. 3 illustrates a basic configuration of the motorized roller shade controlling apparatus. In particular, the illustration provides the left side of an assembled motorized roller shade controlling apparatus. A bracket 22 is connected to an adjacent wall (not shown) with a standard roller shade motor 18 connected to the bracket on one side of the motor. On the other side of the motor is connected one end of a roller shade 14. At the other, second end of the roller shade is a grudgen 20 configured to the end of the roller shade. Illustrated within the grudgen is a square rod 12 that allows interconnection of adjacent grudgens/roller shades.

FIG. 4 illustrates a basic configuration of the motorized roller shade controlling apparatus. In particular, the illustration provides the right side of an assembled motorized roller shade controlling apparatus. A grudgen 20 is provided at the left end of a roller shade 14 and also at the right end of the roller shade. The raised protrusion 28 on the grudgen fits into the hole 24 of the bracket 22 so that the grudgen and roller shade roll smoothly when an attached roller shade motor is activated to unroll the shade 16.

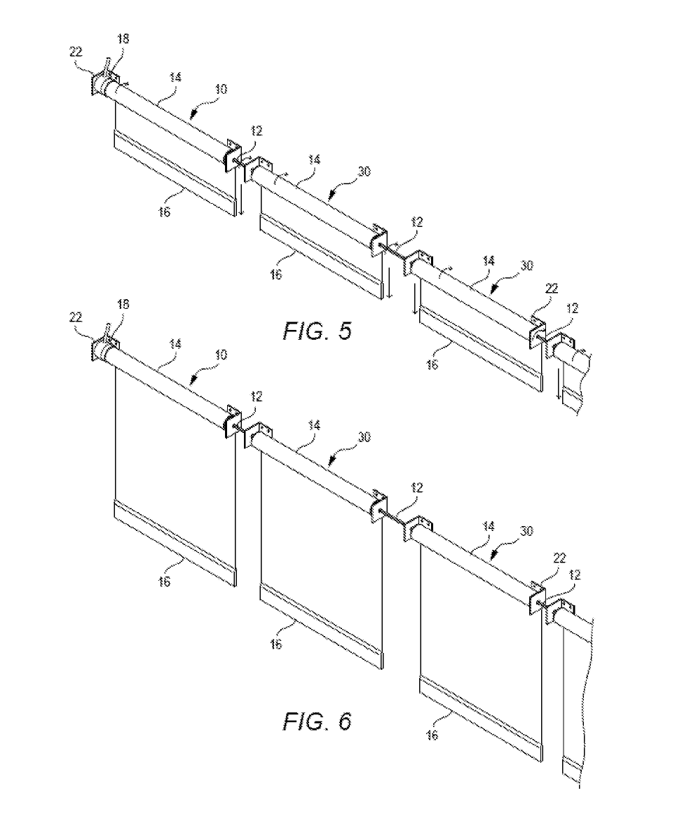

FIG. 5 illustrates a preferred embodiment of the invention wherein the motorized roller shade controlling apparatus 30 is shown with multiple roller shades interconnected to one another. In particular, beginning at the left end of the illustration, a bracket 22 is configured adjacent to a standard roller shade motor 18. In turn, the motor is configured to one end of a first roller shade 14 wherein the roller shade is in the process of unrolling the attached shade 16. The left side of the illustration 10 represents the substance of FIG. 2 with a single roller shade apparatus. The left most roller shade is connected to a second, middle roller shade 14 by a square rod 12 that fits through a hole in the bracket 22 holding the left most roller shade to the wall (not shown). A middle and right most roller shade are connected to the left most roller shade via a series of grudgens configured on the ends of each roller shade as well as a number of square rods that interconnect each of the roller shades and suspended by brackets 22. The illustration provides an instance in which the motorized roller shade controlling apparatus is beginning to unroll all the interconnected roller shades simultaneously.

FIG. 6 illustrates the substance of FIG. 5 however, as shown, the motorized roller shade controlling apparatus has progressed in unrolling all the roller shades to the fullest extent. The motor 18 is designed to either roll or unroll the roller shades of the motorized roller shade controlling apparatus upon activation of the motor by a user. As shown, there is virtually no limit to the number of roller shades that can be interconnected and controlled by the motorized roller shade controlling apparatus and a single roller shade motor.

To manufacture motorized roller shade controlling apparatus, materials and methods known in the art are employed and are envisioned within the scope of the present invention. Grudgens are produced by machining appropriate materials including but not limited to metal, plastic, carbon fiber, fiber glass and other materials of the like. Extrusion of the round protrusion is likewise accomplished with machining appropriate materials for preparation of the grudgen. Certain advantages can be obtained in utilizing the present invention. Foremost, the invention allows a user to save significant time and expense associated with installation of multiple roller shade motors to roll and unroll multiple roller shades in a room or building.

Benefits of the present invention over the prior art also include the ability of a user to employ use of a single motor to roll and unroll multiple roller shades simultaneously thus, allowing fast and efficient coverage of windows during times of high temperatures and cost savings during times of cold weather. Further, the ability to roll and unroll multiple roller shades using only a single motor presents a significant savings to consumers whom possess a multitude of windows in their homes or to businesses housed in buildings with lots of windows.

Although the invention has been described with reference to the above examples, it will be understood that modifications and variations are encompassed within the spirit and scope of the invention. Accordingly, the invention is limited only by the following claims.

What is claimed is:

1. A roller shade controlling apparatus comprising a shade system, said shade system comprising one or more roller shades, one or more brackets, one or more grudgens, one or more square rods, said one or more grudgens comprising a bushing, said grudgens also including a center area configured with a square hole and a round protrusion, said square rods being configured to fit within said square hole of said one or more grudgens wherein said grudgens are configured on both ends of said one or more roller shades, wherein said square rods interconnect said one or more roller shades so that when a first interconnected roller shade is rolled or unrolled, all other interconnected roller shades are rolled or unrolled simultaneously said interconnection comprising the steps of fitting a first end of a first square rod into said square hole of a first grudgen, said first grudgen being fitted onto one end of a first roller shade and wherein the other end of said square rod is fitted into the square hole of a second grudgen, wherein said second grudgen is fitted onto a second roller shade thereby interconnecting said first roller shade to said second roller shade wherein a user interconnects as many roller shades as desired.

2. The roller shade controlling apparatus of claim 1 wherein said shade system further comprises a motor, said motor being capable and possessing sufficient power to roll and unroll said one or more roller shades simultaneously.

3. The roller shade controlling apparatus of claim 2 wherein said one or more roller shades are interconnected with said one or more square rods and one or more said grudgens so that all of said one or more roller shades rolls and unrolls when said motor is turned on.

4. The roller shade controlling apparatus of claim 3 wherein said one or more square rods are flexible so that said one or more roller shades can be interconnected on curved or uneven surfaces.

5. The roller shade controlling apparatus of claim 4 wherein said shade system further comprises a light sensor for automatic activation of said rolling and unrolling of said interconnected roller shades.

6. A kit for assembling a shade system, said shade system comprising, in combination:
a. one or more roller shades;
b. one or more grudgens;
c. one or more brackets;
d. one or more square rods;
wherein said one or more grudgens comprises a bushing, said grudgens also including a center area configured with a square hole and a round protrusion, said square rods being configured to fit within said square hole of said one or more grudgens wherein said grudgens are configured on both ends of said one or more roller shades, wherein said square rods interconnect said one or more roller shades so that when a first interconnected roller shade is rolled or unrolled, all other interconnected roller shades are rolled or unrolled simultaneously said interconnection comprising the steps of fitting a first end of a first square rod into said square hole of a first grudgen, said first grudgen being fitted onto one end of a first roller shade and wherein the other end of said square rod is fitted into the square hole of a second grudgen, wherein said second grudgen is fitted onto a second roller shade thereby interconnecting said first roller shade to said second roller shade wherein a user interconnects as many roller shades as desired.

7. The kit of claim 6 wherein said shade system further comprises a motor, said motor being capable and possessing sufficient power to roll and unroll said one or more roller shades simultaneously

8. The kit of claim 7 wherein said motor is configured at a first end of a first roller shade and a first grudgen is configured at the other end of said first roller shade and wherein a first bracket is configured at said first end of said first roller shade and a second bracket is configured at said other end of said first roller shade.

9. The kit of claim 8 wherein said one or more square rods consist of flexible material so that said one or more roller shades can be interconnected when mounted on curved, rounded or otherwise uneven surfaces.

10. A method of rolling and unrolling one or more roller shades comprising assembly of a roller shade system that includes one or more brackets, one or more grudgens, one or more square rods, one or more roller shades and at least one motor capable of rolling and unrolling said one or more roller shades simultaneously wherein said one or more grudgens are configured with raised protrusions, wherein said raised protrusions are configured with a square hole in the center, wherein said square hole acts to receive one end of a first square rod and the other end of said first square rod is designed to fit into a square hole configured into an adjacent grudgen installed on one end of an adjacent roller shade, wherein said assembly comprises the steps of connecting said motor to one end of a first roller shade and connecting a first grudgen to the other end of said first roller shade, wherein said first grudgen is fitted with one end of a first square rod and said first square rod fits through an opening in a first said bracket, and the other end of said first square rod fits into a square hole on a second grudgen, the second grudgen being connected to a second roller shade wherein said first roller shade is interconnected with said second roller shade wherein said motor, when activated, will roll and unroll said first and second roller shades.

11. The method of claim 10 wherein said assembly further comprises the steps of fitting a first end of a first square rod into said square hole of a first grudgen, said first grudgen being fitted onto one end of a first roller shade and wherein the other end of said square rod is fitted into the square hole of a second grudgen, wherein said second grudgen is fitted onto a second roller shade thereby interconnecting said first roller shade to said second roller shade wherein a user interconnects as many roller shades as desired.

12. The method of claim 11 wherein said motor rolls and unrolls a plurality of roller shades simultaneously wherein said plurality of roller shades are interconnected with a plurality of square rods and a plurality of grudgens wherein said roller shade controlling apparatus are configured with a plurality of brackets that attach said apparatus to a wall or other flat surface.

13. The method of claim 12 wherein said one or more square rods are comprised of a flexible material so that said one or more roller shades can be interconnected on a curved, rounded or uneven wall surface.

14. The method of claim 13 wherein said roller shade controlling apparatus is controlled manually.
